(19) United States
(12) Patent Application Publication
(10) Pub. No.: US 2025/0232321 A1
(43) Pub. Date: Jul. 17, 2025

(54) INFORMATION GENERATION DEVICE, INFORMATION GENERATION METHOD, AND STORAGE MEDIUM

(71) Applicant: NEC Corporation, Tokyo (JP)

(72) Inventors: Hironori TSUCHIYA, Tokyo (JP); Kiyoshi SHIOZAWA, Tokyo (JP); Takahiro MURAMATSU, Tokyo (JP); Hiroaki KOSHIO, Tokyo (JP); Akira YAMANAKA, Tokyo (JP)

(73) Assignee: NEC Corporation, Tokyo (JP)

(21) Appl. No.: 19/001,641

(22) Filed: Dec. 26, 2024

(30) Foreign Application Priority Data
Jan. 12, 2024 (JP) 2024-003343

(51) Int. Cl. G06Q 30/0201; G06N 20/00; G06Q 30/0601

(52) U.S. Cl. CPC G06Q 30/0201; G06N 20/00; G06Q 30/0635

(57) ABSTRACT

An information generation device generates second output information indicating a characteristic of an individual by inputting second input information based on the individual's product purchase history into a first model, wherein the first model outputs first output information indicating a characteristic in respect to receiving input of first input information based on product purchase history.

### CROSS-REFERENCE TO RELATED APPLICATIONS

This application is based upon and claims the benefit of priority from Japanese patent application No. 2024-003343, filed on Jan. 12, 2024, the disclosure of which is incorporated herein in its entirety by reference.

### TECHNICAL FIELD

The present disclosure relates to an information generation device, an information generation method, and a storage medium.

### BACKGROUND ART

In certain cases, a survey is conducted with customers to acquire information about their values, which is then used for marketing purposes.

For example, Japanese Unexamined Patent Application, First Publication No. 2021-043899 discloses conducting a survey with customers to categorize them into value clusters.

### SUMMARY

It is desirable to be able to obtain information indicating the characteristics of an individual who has not participated in a survey.

An example of an object of the present disclosure is to provide an information generation device, an information generation method, and a program capable of solving the problem mentioned above.

According to a first example aspect of the present disclosure, an information generation device generates second output information indicating a characteristic of an individual by inputting second input information based on the individual's product purchase history into a first model, wherein the first model outputs first output information indicating a characteristic in respect to receiving input of first input information based on product purchase history.

According to a second example aspect of the present disclosure, an information generation method includes a step, performed by a computer, of generating second output information indicating a characteristic of an individual by inputting second input information based on the individual's product purchase history into a first model, wherein the first model outputs first output information indicating a characteristic in respect to receiving input of first input information based on product purchase history.

According to a third example aspect of the present disclosure, a storage medium storing a program that causes a computer to execute a step of generating second input information indicating a characteristic of an individual by inputting second input information based on the individual's product purchase history into a first model, wherein the first model outputs first output information indicating a characteristic in respect to receiving input of first input information based on product purchase history.

### BRIEF DESCRIPTION OF THE DRAWINGS

FIG. 1 is a diagram showing a configuration example of a sales strategy support system according to at least one of example embodiments.

FIG. 2 is a diagram showing a configuration example of an information generation device 100 according to at least one of the example embodiments.

FIG. 3 is a diagram showing a data structure example of product purchase data according to at least one of the example embodiments.

FIG. 4 is a diagram showing a data structure example of survey data according to at least one of the example embodiments.

FIG. 5 is a diagram showing a data structure example of product data according to at least one of the example embodiments.

FIG. 6 is a diagram showing a data structure example of awareness score data according to at least one of the example embodiments.

FIG. 7 is a diagram showing a data structure example of product score data according to at least one of the example embodiments.

FIG. 8 is a diagram showing a data structure example of product score aggregate data according to at least one of the example embodiments.

FIG. 9 is a diagram showing a data structure example of awareness segment data according to at least one of the example embodiments.

FIG. 10 is a diagram showing a data structure example of segment proportion data according to at least one of the example embodiments.

FIG. 11 is a diagram showing an example of a procedure through which an information generation device 100 according to at least one of the example embodiments performs preprocessing.

FIG. 12 is a diagram showing an example of a procedure through which the information generation device 100 according to at least one of the example embodiments performs processing using product purchase data of a member.

FIG. 13 is a diagram showing an example of a procedure through which the information generation device 100 according to at least one of the example embodiments performs processing of inviting a member to a product.

FIG. 14 is a diagram showing another configuration example of an information generation device according to at least one of the example embodiments.

FIG. 15 is a diagram showing an example of a procedure of processing in an information generation method according to at least one of the example embodiments.

FIG. 16 is a diagram showing a configuration example of a computer according to at least one of the example embodiments.

### EXAMPLE EMBODIMENT

Hereinafter, example embodiments of the present disclosure will be described, however, the present disclosure within the scope of the claims is not limited by the following example embodiments. Furthermore, not all the combinations of features described in the example embodiments are essential for the solving means of the disclosure.

### First Example Embodiment

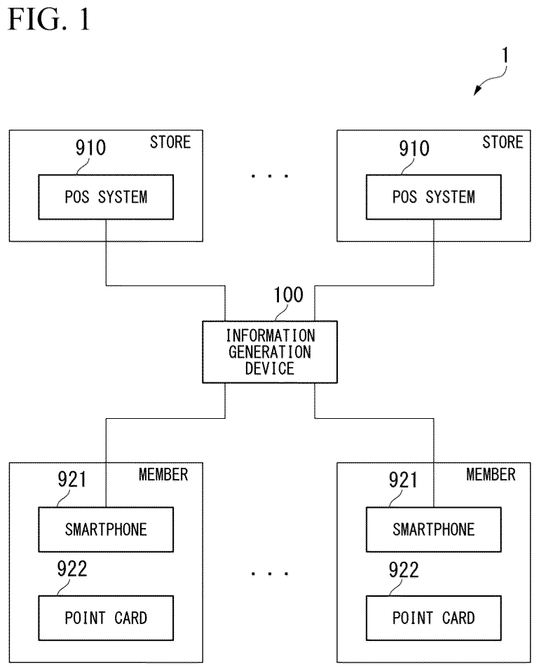

FIG. 1 is a diagram showing a configuration example of a sales strategy support system according to at least one of the example embodiments. In the configuration shown in FIG. 1, the sales strategy support system 1 includes an information generation device 100, point of sales (POS) systems 910, smartphones 921, and point cards 922. The POS system 910 is installed at each store. The smartphone 921 and the point card are held by each point service member.

However, the individuals targeted by the sales strategy support system 1 are not limited to point service members, as long as each individual can be identified. For example, the card used in the sales strategy support system 1 may be issued separately from the point card. Each individual may be identified by the card number on that card.

The sales strategy support system 1 is a system that assists in sales strategies at the store. The products targeted by sales strategies are not limited to specific items. In particular, the products targeted by sales strategies may be goods, services, or a combination of both goods and services.

The point card 922 is a card that a member presents at a store to receive point services. At the time of acquiring the point card 922, or afterward, the member may register their own information, but the disclosure is not limited to this example. The point card 922 is identified by an identification number (card number), which allows identification of the member who presented the point card 922 at the store and made a purchase.

Moreover, the function of the point card 922 may be implemented as one of the functions of the smartphone 921, and the point card functionality may also be provided in a form other than a physical card.

The following describes an example in which a point card member is the target, and the information generation device 100 generates data related to that member. However, as mentioned above, the individual for whom the information generation device 100 generates data is not limited to being a point card member, and it is sufficient if the individual can be identified by any means. For example, the card used in the sales strategy support system 1 may be issued separately from the point card. Each individual may be identified by the card number on that card.

The smartphone 921 is used by the member to receive information, such as product introductions and other relevant information. For example, the member may send an email containing the card number of the point card 922 from the smartphone 921 to the information generation device 100, thus associating the smartphone 921 with the card number of the point card 922.

However, the manner in which the member receives information is not limited to a specific form. For example, the member may receive information through an email on a personal computer (PC) or through a direct mail. Also, the member may receive information at the store, for example by receiving a flyer at the store checkout.

The POS system 910 converts the sales at the store into data. In particular, the POS system 910 generates product purchase data for the member who presented the point card 922 and made a purchase, and transmits the generated product purchase data to the information generation device 100.

The information generation device 100 generates information for assisting in sales strategies. The information generation device 100 may be configured, using a computer. Moreover, the information generation device 100 may be configured using multiple devices, such as a combination of a computer for generating information and a database machine.

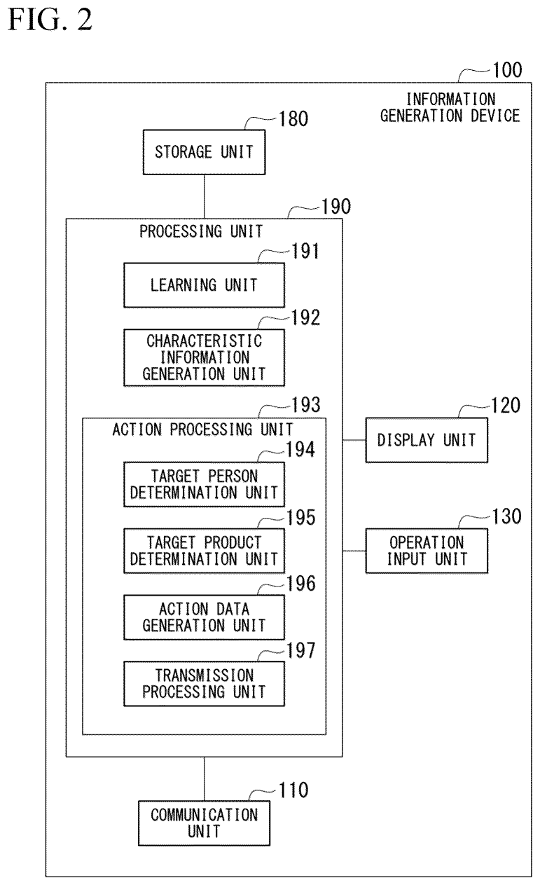

FIG. 2 is a diagram showing a configuration example of the information generation device 100. In the configuration shown in FIG. 2, the information generation device 100 includes a communication unit 110, a display unit 120, an operation input unit 130, a storage unit 180, and a processing unit 190. The processing unit 190 includes a learning unit 191, a characteristic information generation unit 192, and an action processing unit 193. The action processing unit 193 includes a target individual determination unit 194, a target product determination unit 195, an action data generation unit 196, and a transmission processing unit 197.

The communication unit 110 communicates with other devices. For example, the communication unit 110 may receive product purchase data from the POS system 910. Moreover, the communication unit 110 may also transmit to the smartphone 921 information to be provided to members, such as product introductions.

The display unit 120 includes a display screen such as a liquid crystal panel or an LED (light emitting diode) panel, and acquires various types of images. For example, the display unit 120 may display various types of information generated as information for assisting in sales strategies.

The operation input unit 130 includes input devices such as a keyboard and a mouse, and accepts user operations. For example, the operation input unit 130 may accept a user operation that instructs to generate information for assisting in sales strategies.

The storage unit 180 stores various types of data. The storage unit 180 is configured using a memory storage device included in the information generation device 100.

The storage unit 180 may store various data used for generating information for assisting in sales strategies, and information for assisting in sales strategies generated by the information generation device 100. For example, the storage unit 180 may store product purchase data, survey data, product data, awareness score data, product score data, product score aggregate data, awareness segment data, and segment proportion data.

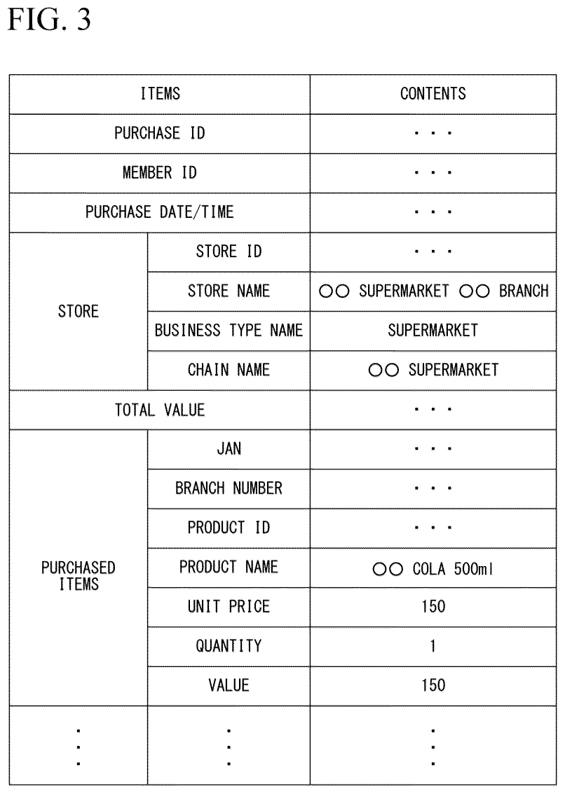

FIG. 3 is a diagram showing a data structure example of product purchase data. The product purchase data refers to data related to product purchases made by customers, including members, generated by the POS system 910. The POS system 910 transmits the generated product purchase data to the information generation device 100.

In the example of FIG. 3, the product purchase data includes the following fields: “Purchase ID”, “Member ID”, “Purchase date/time”, “Store”, “Total value”, and “Purchased product”. The “Store” field includes the following subfields: “Store ID”, “Store name”, “Business type name”, and “Chain name”. The “Purchased product” field includes the following subfields: “JAN”, “Branch number”, “Product ID”, “Product name”, “Unit price”, “Quantity”, and “Value”.

The “Purchase ID” field stores the purchase ID. The purchase ID is identification information for identifying the product purchase data.

The “Member ID” field stores the member ID of the purchaser. The member ID is identification information for identifying the member. The card number of the point card 922 held by the member can be used as the member ID. In the product purchase data, the “member ID” field stores the card number of the point card 922 presented by the purchaser at the time of purchase.

The “Purchase date/time” field stores the date and time when the purchase occurred.

The “Store” field stores information about the store where the purchase occurred.

The “Store ID” field stores the store ID of the store where the purchase occurred. The store ID is identification information for identifying the store.

The “Store name” field stores the name of the store where the purchase occurred.

The “Business type name” field stores the business type name of the store where the purchase occurred.

The “Chain name” field stores the chain name if the store where the purchase occurred is a chain store. Here, a chain store refers to a corporate chain, and the “Chain name” field may store the company name.

However, the configuration (data structure) of the data stored in the “Store” field is not limited to a specific configuration and may be any configuration that allows the identification of the store where the purchase occurred. For example, the product purchase data may include only a store ID as information in the “Store” field.

The “Total value” field stores the total value of the purchased products.

The “Purchased product” field stores information related to the purchased product. In a case where multiple types of products are purchased in a single transaction, the “Purchased product” field is provided in the product purchase data for each type of product purchased.

The “JAN” field stores the JAN code (GTIN) of the purchased product.

The “Branch number” field stores a branch number that indicates the variation of the product identified by the JAN code in the “JAN” field, if there is a variation of the product.

The “Product ID” field stores the product ID of the purchased product. The product ID is an identification number that identifies a product. Products with the same product ID will be treated as the same product. Products identified by the product ID are also referred to as product types. In other words, products assigned the same product ID are also referred to as products of the same type.

The “Product name” field stores the name of the purchased product.

The “Unit price” field stores the unit price of the purchased product.

The “Quantity” field stores the number of units of the product (the product type identified by the product ID in the “Product ID” field) purchased.

The “Value” field stores the purchase value of the product. Unless a discount or the like is applied, the purchase value of the product is calculated by multiplying the unit price of the product by the quantity.

However, the configuration of the product purchase data is not limited to a specific configuration. For example, for the purpose of generating awareness score data that indicates the psychological characteristics of a member, the product purchase data may be in various configurations that allow the identification of both the member who purchased the product and the purchased product. For the purpose of generating time-series data for member-based score data, the product purchase data may be configured in various ways that allow the identification of the member and the purchased product and the specification of the purchase date/time. For the purpose of gaining a grasp of products being purchased at a given store, the product purchase data may take various configurations that allow the identification of both the store and the purchased product.

As shown in the example of FIG. 3, with the member ID and purchase date/time indicated in the product purchase data, it is possible to retrieve the product purchase history of each member from the product purchase data. Thus, the product purchase data is an example of data indicating a product purchase history.

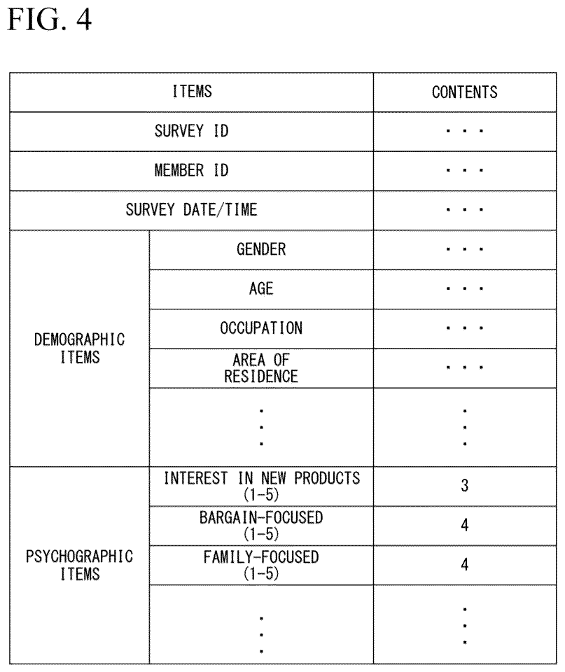

FIG. 4 is a diagram showing a data structure example of survey data. Survey data indicates the results of a survey conducted on members. The survey is conducted among a portion of the members.

Members that respond to the survey are referred to as respondents or monitors.

In the example of FIG. 4, the survey data includes the following fields: “Survey ID”, “Member ID”, “Survey date/time”, “Demographic items”, and “Psychographic items”, The “Demographic items” field includes the following subfields: “Gender”, “Age” “Occupation”, and “Place of residence”. The “Psychographic items” field includes the following subfields: “Interest in new products”, “Bargain-focused”, and “Family-focused”.

The “Survey ID” field stores the survey ID. The survey ID is identification information for identifying the survey.

The “Member ID” field stores the member ID of the respondent. In the survey data. the “Member ID” field stores the card number of the point card 922 held by the respondent. The “Survey date/time” field stores the date and time when the member responded to the survey.

The “Demographic items” field contains demographic (demographic, statistical) information. Demographic items can be viewed as items whose information is objectively observable. Demographic items may also include geographic items.

The “Gender” field stores the gender of the respondent.

The “Age” field stores the age of the respondent.

The “Occupation” field stores the occupation of the respondent.

The “Place of residence” field stores the place of residence of the respondent.

However, the demographic items included in the survey data are not limited to specific items and may include various items that can be objectively determined.

The “Psychographic items” field stores psychographic information. Psychographic items can be viewed as items that relate to the psychology of the respondent. The survey serves as an example of investigating the psychological characteristics of the survey target individuals.

The survey data may also include responses to objective fact-based items, such as whether or not the respondent owns a private vehicle (that is, items that are not psychographic in nature). Objective fact-based items may be provided as part of the demographic items, or they may be provided as separate items, distinct from both demographic items and psychographic items.

The “Interest in new products” field stores the respondent's degree of interest in new products. In the example of FIG. 4, the respondent's degree of interest in new products is indicated on a five-step scale of integers 1 to 5. The greater the integer value, the greater the interest in the new product.

The “Bargain-focused” field stores the respondent's degree of focus placed on bargains. In the example of FIG. 4, the respondent's degree of focus placed on bargains is indicated on a five-step scale of integers 1 to 5. The greater the integer value, the greater the focus placed on bargains.

The “Family-focused” field stores the respondent's degree of focus placed on their family. In the example of FIG. 4, the respondent's degree of focus placed on their family is indicated on a five-step scale of integers 1 to 5. The greater the integer value, the greater the focus placed on their family.

However, the psychographic items included in the survey data are not limited to specific items and may include a variety of items related to the respondent's subjective views. In particular, the psychographic items in the survey data may correspond to items found in the awareness score data, which indicates the member's psychological characteristics.

The configuration of the survey data is not limited to a specific configuration. For example, for the purpose of extracting characteristics of respondents, the survey data can be configured in various ways that allow identification of the respondent and specification of their characteristics. For the purpose of extracting the respondent's characteristic history, the survey data can be configured in various ways that allow identification of the respondent and specification of the date and time when the respondent responded to the survey and the respondent's characteristics.

The information generation device 100 also estimates the characteristics of members who were excluded from the survey or did not respond to the survey, based on the survey results.

The following describes an example in which the information generation device 100 estimates a member's psychological characteristics. The psychological characteristics of an individual, as referred to here, can be considered those characteristics that are not objectively observable but are still part of the individual's overall characteristics.

However, the information generation device 100 may estimate non-psychological characteristics, either alongside or as a replacement for psychological characteristics. For example, the information generation device 100 may estimate a member's age based on that member's purchase history. In such a case, for example, in a case where determining whether or not to introduce a product with a specified target age group to a member, the age of the member estimated by the information generation device 100 can be utilized.

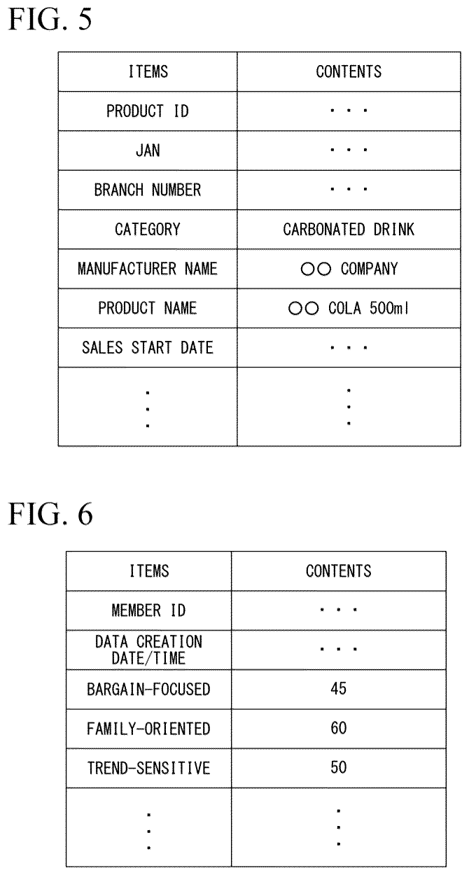

FIG. 5 is a diagram showing a data structure example of product data. The product data refers to data relating to individual products. In the description of the product data, the target products of the product data are also referred to as target products.

In the example of FIG. 5, the product data includes the following fields: “Product ID”, “JAN”, “Branch number”, “Category”, “Manufacturer name”, “Product name”, and “Sales start date”.

The “Product ID” field stores the product ID of the target product.

The “JAN” field stores the JAN code (GTIN) of the target product.

The “Branch number” field stores a branch number that indicates the variation of the product identified by the JAN code in the “JAN” field, if there is a variation of the product.

The “Category” field stores the category into which the target product is classified (category of target product).

The “Manufacturer name” field stores the manufacturer name of the target product.

The “Product name” field stores the name of the target product.

The “Sales start date” field stores the sales start date and time of the target product.

However, the configuration of the product data is not limited to a specific configuration. The product data can have various configurations depending on the contents of the sales strategy and can be referenced for formulating the sales strategy. Furthermore, in a case where the information generation device 100 generates the awareness score data, the product data is not essential.

FIG. 6 is a diagram showing a data structure example of awareness score data. The awareness score data refers to data in which an individual's psychological characteristics are scored (numericalized, quantified) for each characteristic item.

The score for each psychological characteristic item in the awareness score data is also referred to as awareness score. The items of psychological characteristics are also referred to as psychological characteristic items. The awareness score is an example of information that indicates an individual's psychological characteristic. The awareness score indicated by the awareness score data is an example of information that, for an individual, indicates a degree of applicability for each psychological characteristic item set as an item of a psychological characteristic.

In the description of the awareness score data, the target individuals of the awareness score data are also referred to as target individuals.

The awareness score data of monitors (survey respondents) is also referred to as monitor awareness score data. The information generation device 100 generates monitor awareness score data for each monitor based on the survey data. Alternatively, the information generation device 100 may acquire monitor awareness score data generated by another device or a person.

The awareness score data of not only monitors but also members is also referred to as member awareness score data.

In the example of FIG. 6, the awareness score data includes the following fields: “Member ID”, “Data creation date/time”, “Bargain-focused”, “Family-oriented”, and “Trend-sensitive”.

The “Member ID” field stores the member ID of the target individual.

The “Data creation date/time” field stores the date and time when the awareness score data was created.

The items “Bargain-focused”, “Family-oriented”, and “Trend-sensitive” are examples of psychological characteristic items.

The “Bargain-focused” field stores a score value (bargain focus score value) that indicates the target individual's degree of focus placed on bargains. The higher the score value, the greater the focus placed on bargains.

The “Family-oriented” field stores a score value (family orientation score value) that indicates the target individual's degree of focus placed on their family. The higher the score value, the greater the focus placed on their family. The “Trend-sensitive” field stores a score value (trend sensitivity score value) that indicates the degree to which the target individual is sensitive to trends. The higher the score value, the more sensitive the individual is to trends.

However, the configuration of the awareness score data is not limited to a specific configuration. In particular, the psychological characteristic items included in the awareness score data can be various items depending on the contents of the sales strategy, which are referenced for the formulating sales strategies.

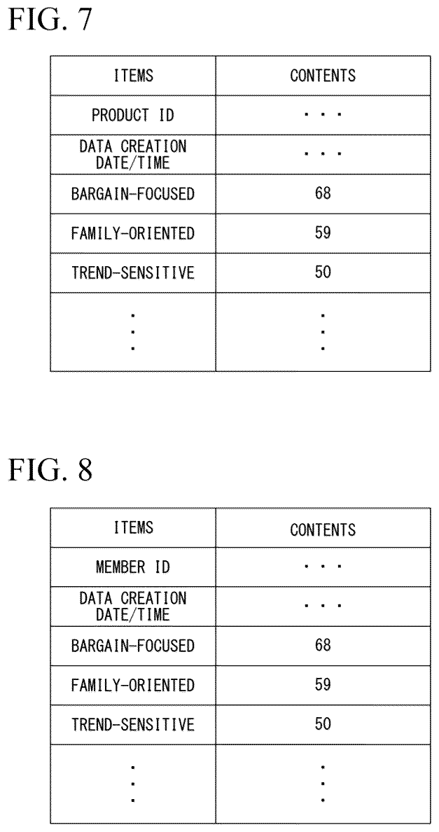

FIG. 7 is a diagram showing a data structure example of product score data. The product score data refers to data that assigns scores to the psychological characteristics of the purchasers of each product for each characteristic item, for each individual product. In the description of the product score data, the target products of the product score data are also referred to as target products.

The score for each psychological characteristic item in the product score data is also referred to as product score. The product score is an example of information indicating the relevance between the target product and each of the psychological characteristic items.

For example, the same psychological characteristic items included in the awareness score data may also be set as the psychological characteristic items in the product score data. Additionally, the information generation device 100 may determine the average awareness score for each psychological characteristic item of the individuals who purchased the target product and use that as the product score value.

As mentioned above, the information generation device 100 may estimate non-psychological characteristics, either alongside or as a replacement for psychological characteristics. In such a case, the awareness score data may be generalized to include non-psychological characteristic items. In such a case, the generalized data is also referred to as human characteristic score data. Furthermore, both psychological characteristics and non-psychological characteristics are also collectively referred to as human characteristics. The awareness score (psychological characteristics score) and the score for non-psychological characteristics are collectively referred to as human characteristic scores.

In the example of FIG. 7, the product score data includes the following fields: “Product ID”, “Data creation date/time”, “Bargain focused”, “Family-oriented”, and “Trend-sensitive”.

The “Product ID” field stores the product ID of the target product.

The “Data creation date/time” field stores the date and time when the product score data was created.

The “Bargain focused” field stores a score value that indicates the degree of focus placed on bargains by the purchaser of the product.

The “Family-oriented” field stores a score value that indicates the degree of focus placed on family by the purchaser of the product.

The “Trend-sensitive” field stores a score value that indicates the degree of sensitivity to trends by the purchaser of the target product.

As mentioned above, the items “Bargain focused”, “Family-oriented”, and “Trend-sensitive” are examples of psychological characteristic items. The score values for the degree of bargain focusedness, degree of family-orientedness, and degree of trend sensitivity in the example of FIG. 7 are examples of product score values.

However, the configuration of the product score data is not limited to a specific configuration.

Moreover, as mentioned above, the same psychological characteristic items included in the product score data may also be set as the psychological characteristic items in the awareness score data.

FIG. 8 is a diagram showing a data structure example of product score aggregate data. The product score aggregate data refers to data in which the product score values of products purchased by each individual are aggregated for each product score item.

The aggregated product score value is also referred to as a product score aggregate value. The product score aggregate value is an example of information based on a purchase history of a certain product by a certain individual. Furthermore, the product score aggregate value is an example of information obtained by aggregating, for an individual, the product score values of products purchased by the individual. As mentioned above, the product score is an example of information that, for each product, indicates the relevance between the product and each of the psychological characteristic items.

In the description of the product score aggregate data, the target individuals of the product score aggregate data are also referred to as target individuals.

For example, the product score aggregate value may be an average value of the product score values of the products purchased by the target individual within a predetermined period for each product score item. In such a case, the aggregation method for calculating the product score aggregate value from product scores can be viewed as averaging.

However, the aggregation method used to calculate the product score aggregate value from product score values is not limited to averaging. For example, the aggregation method used to calculate the product score aggregate value may be any of taking the sum, finding the median value, finding the mode value, finding the maximum value, or finding the minimum value. In other words, the product score aggregate value may be the total, median, mode, maximum, or minimum product score value for each product score item of the products purchased by the target individual within a predetermined period.

In the example of FIG. 8, the product score aggregate data includes the following fields: “Member ID”, “Data creation date/time”, “Bargain-focused”, “Family-oriented”, and “Trend-sensitive”.

The “Member ID” field stores the member ID of the target individual.

The “Data creation date/time” field stores the date and time when the product score aggregate data was created.

The “Bargain-focused” field stores a score value that indicates the degree of focus placed on bargains by the purchaser of the product.

The “Family-oriented” field stores a score value that indicates the degree of focus placed on family by the purchaser of the product.

The “Trend-sensitive” field stores a score value that indicates the degree of sensitivity to trends by the purchaser of the target product.

As mentioned above, the items “Bargain-focused”, “Family-oriented”, and “Trend-sensitive” are examples of psychological characteristic items. The score values for the degree of bargain-focusedness, degree of family-orientedness, and degree of trend sensitivity in the example of FIG. 8 are examples of product score aggregate values.

The data structure of the product score aggregate data may include data for identifying the target individual instead of data for identifying the target product, within the data structure of the product score data, and it may include the product score aggregate data as the score value, instead of the product score value. The same psychological characteristic items included in the product aggregate score data may also be set as the psychological characteristic items in the product score data.

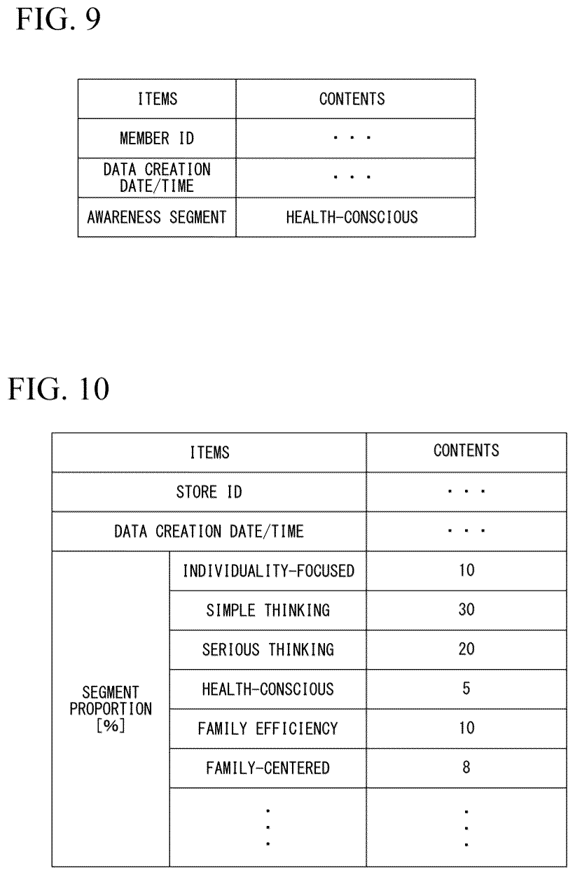

FIG. 9 is a diagram showing a data structure example of awareness segment data. The awareness segment, as referred to here, is a class in which an individual's psychological characteristics are classified. The awareness score data refers to data that indicates the classification result of an individual's psychological characteristics, as represented by the awareness score data. Classification of individual's psychological characteristics can also be viewed as classification of individuals based on their psychological characteristics.

A class in the classification of psychological characteristics is also referred to as psychological characteristic class.

In the description of the awareness segment data, the target individuals of the awareness segment data are also referred to as target individuals.

In the example of FIG. 9, the awareness segment data includes the following fields: “Member ID”, “Data creation date/time”, and “Awareness segment”.

The “Member ID” field stores the member ID of the target individual.

The “Data creation date/time” field stores the date and time when the awareness segment data was created.

The “Awareness segment” field stores the class name corresponding to the classified psychological characteristic. “Health-conscious” shown in FIG. 9 is an example of a class name.

However, the configuration of the awareness segment data is not limited to a specific configuration and can take various configurations that can indicate the class classification results of an individual's psychological characteristics.

Moreover, the number and types of classes in the classification of an individual's psychological characteristics are not limited to a specific number and types of classes, and they can vary, depending on the contents of the sales strategy and the psychological characteristic items in the awareness score data.

FIG. 10 is a diagram showing a data structure example of segment proportion data. The segment proportion data refers to data that represents the proportion of individuals classified into each class in the class classification result based on psychological characteristics. In this case, the proportion of individuals classified into each class is also referred to as segment proportion.

FIG. 10 shows an example of the configuration of segment proportion data for each store. In this case, the target store of the segment proportion data is also referred to as corresponding store.

In the example of FIG. 10, the segment proportion data includes the following fields: “Store ID”, “Data creation date/time”, and “Segment proportion”.

The “Store ID” field stores the store ID of the corresponding store.

The “Data creation date/time” field stores the date and time when the segment proportion data was created. The “Segment proportion” field indicates the proportion of individuals classified into each psychological characteristic class. Each of “Individuality-focused”, “Simple thinking”, “Serious thinking”, “Health-conscious”, “Family-efficient”, and “Family-oriented” shown in FIG. 10 are examples of psychological characteristic class names.

However, the configuration of the segment proportion data is not limited to a specific configuration. The information generation device 100 may generate segment ratio data for each chain (of chain stores). In such a case, the segment proportion data may have a field for identifying the chain instead of the “Store ID” field.

The processing unit 190 controls each unit of the information generation device 100 and executes various processes. Functions of the processing unit 190 are executed by a central processing unit (CPU) included in the information generation device 100 reading out a program from the storage unit 180 and executing the program.

The learning unit 191 performs machine learning of a machine learning model used to generate awareness score data of non-monitor members.

The learning unit 190 is an example of the learning means.

The machine learning model here is not limited to a specific type. For example, a Neural Network (NN) may be used as the machine learning model, but is not limited to this example. Machine learning is also simply referred to as learning. The machine learning model is also referred to simply as model.

The learning of a model here refers to adjusting the parameter values of the model using training data. Learning of a model (learning) can also be referred to as training a model (training).

The learning unit 191 uses the vector of product score aggregate values from the product score aggregate data for each monitor as input to the model, and the vector of awareness score values from the awareness score data for that monitor as the ground truth, to train the model using training data. The learning unit 191 performs model learning to minimize the difference between the vector of awareness score values obtained as the model output in a case where the vector of product score aggregate values is input, and the vector of awareness score values shown as the ground truth.

As a result, the learning unit 191 generates a model that outputs awareness score values upon receiving the input of product score aggregate values.

The model used to generate the awareness score data is also referred to as an awareness score data generation model. The awareness score data generation model is an example of a model that, in response to input information based on product purchase history (such as product score aggregate values), outputs information indicating characteristics (such as human characteristic score values or awareness score values).

The input to the awareness score data generation model is not limited to product score aggregate data and can include various types of data based on product purchase history. For example, the awareness score data generation model may accept as input the product data of products most recently purchased a predetermined number of times in the purchase history of the target individual of the awareness score data.

However, the learning method used by the learning unit 191 is not limited to a specific method. For example, the learning unit 191 may perform learning of the model using backpropagation, but it is not limited to this method.

Moreover, the measure of the magnitude of the difference between the vectors mentioned here is not limited to a specific one. For example, the learning unit 191 may use squared error as a measure of the magnitude of the difference between the vectors, however, the disclosure is not limited to this example.

The learning unit 191 may perform model re-learning. For example, the information generation device 100 may generate the product score aggregate data and awareness score data for the respondents of the survey each time new survey data is obtained. Then, the learning unit 191 may perform learning of the model using a training dataset that includes training data based on the product score aggregate data and the awareness score data.

The learning unit 191 may perform re-learning of the model using fine tuning, or it may perform re-learning of the model using transfer learning.

Also, a single model may be provided for each store. The learning unit 191 may perform the learning of the model for each member, using the product score aggregate values obtained by aggregating the product score values of the products purchased by the member that are sold at the store that is a target store of the model.

The product score aggregate values obtained by aggregating the product score values of the products purchased by a certain member that are sold at the store that is a target store of the learning target model, correspond to an example of information aggregated for each purchaser by each psychological characteristic item, showing relevance between each product sold at the store that is the target store of the learning target model and each psychological characteristic item.

The learning unit 191 may perform the learning of the model using the product score aggregate values of all members who have a purchase history for products sold at the store that is the target store of the learning target model. Alternatively, the learning unit 191 may perform the learning of the model using the product score aggregate values of members who have a purchase history at the store that is the target store of the learning target model.

The learning unit 191 performs the learning of the model using information based on the purchase history of products sold at the store that is the target store of the learning target model, resulting in using training data that excludes products not sold at the store. Performing the learning of the model using training data that excludes products not sold at the target store can be viewed as training the model using noise-free training data, and in this regard, it is expected that the learning unit 191 will be able to perform the learning of the model with relatively high accuracy.

Alternatively, a model may be provided for each chain (of chain stores). The learning unit 191 may perform the learning of the model for each member, using the product score aggregate values obtained by aggregating the product score values of the products purchased by the member that are sold by the chain that is a target chain of the model.

The learning unit 191 may perform the learning of the model using the product score aggregate values of all members who have a purchase history for products sold by the chain that is the target chain of the model. Alternatively, the learning unit 191 may perform the learning of the model using the product score aggregate values of members who have a purchase history from the chain that is the target chain of the learning target model.

The learning unit 191 performs the learning of the model using the product score aggregate values for products sold by the chain that is the target chain of the learning target, resulting in using training data that excludes products not sold by the chain. Performing the learning of the model using training data that excludes products not sold by the target chain can be viewed as training the model using noise-free training data, and in this regard, it is expected that the learning unit 191 will be able to perform the learning of the model with relatively high accuracy.

The characteristic information generation unit 192 generates awareness score data. In particular, the characteristic information generation unit 192 uses the machine learning model obtained through the machine learning performed by the learning unit 191 to generate awareness score data of non-monitor members.

The characteristic information generation unit 192 is an example of the characteristic information generation means.

Specifically, the characteristic information generation unit 192 generates product score aggregate data for the member targeted for the calculation of awareness score data. Then, the characteristic information generation unit 192 inputs the generated product score aggregate data into the machine learning model obtained through the machine learning performed by the learning unit 191, and calculates the awareness score data for the member.

In generating the product score aggregate data, the characteristic information generation unit 192 may calculate the product score aggregate value for a member targeted for the calculation of awareness score data by calculating the average product score value for each item of products purchased by the member within a predetermined period based on the product purchase history of the member.

In addition, the characteristic information generation unit 192 may generate data used by the learning unit 191 for performing model learning.

For example, the characteristic information generation unit 192 may generate monitor awareness score data based on survey data indicating the results of a survey given to the monitors (the monitors' responses to the survey).

The method by which the characteristic information generation unit 192 generates the monitor awareness score data from survey data is not limited to a specific one. For example, the psychographic items in the survey may include the same items as those in the monitor awareness score. Then, the characteristic information generation unit 192 may convert the responses to the psychographic items in the survey into scores and generate the monitor awareness score data. For example, the characteristic information generation unit 192 may calculate the score by multiplying the responses to a five-step scale of integers 1 to 5 by 20.

Then, the characteristic information generation unit 192 may generate product score data based on the monitor awareness score data.

The method by which the characteristic information generation unit 192 generates the product score data based on the monitor awareness score data is not limited to a specific one. For example, the items of the product score data may be the same as the items of the awareness score data. Then, the characteristic information generation unit 192 may calculate the average value for each item of the awareness scores of the monitors who purchased a certain product, as the product score value of the product.

In such a case, the product score is an example of information that aggregates the awareness scores for each psychological characteristic item for each individual who purchased the target product (the product targeted for product score calculation), for each psychological characteristic item. The awareness score is an example of information indicating the degree of applicability of a certain psychological characteristic item to a certain individual.

Then, the characteristic information generation unit 192 may generate product score aggregate data based on the product score data.

For example, as mentioned above, the product score aggregate value may be an average value of the product score values of the products purchased by the target individual within a predetermined period for each product score item. Then, the characteristic information generation unit 192 may calculate the product score aggregate value by averaging the product score values for each item.

Alternatively, as mentioned above, the product score aggregate value may be the total, median, mode, maximum, or minimum product score value for each product score item of the products purchased by the target individual within a predetermined period. Then, the characteristic information generation unit 192 may calculate the product score aggregate value by calculating the total, median, mode, maximum, or minimum value for each item of the product score values.

However, it is not essential for the characteristic information generation unit 192 to generate the monitor awareness score data, product score data, and product score aggregate data. For example, a device other than the information generation device 100 may generate one or more of these datasets.

Also, the characteristic information generation unit 192 may generate the awareness segment data and the segment proportion data.

Regarding the generation of awareness segment data, for each psychological characteristic class (awareness segment class), the values for each item of the awareness score may be weighted and summed, and an equation may be defined to calculate the score value of the class (for example, the likelihood of class classification). Then, the characteristic information generation unit 192 may calculate the score value for each class for each member and determine the class with the highest score value as the psychological characteristic class of the member.

Alternatively, a rule for determining the class of awareness segment based on the values of each awareness score item may be modeled. Then, the characteristic information generation unit 192 may input the values of each awareness score item into the model for each member and determine the awareness segment for that member.

Regarding the generation of segment proportion data, the characteristic information generation unit 192 may calculate the proportion of members belonging to each psychological characteristic class among the members targeted for segment proportion calculation. For example, in the case where the characteristic information generation unit 192 generates segment proportion data for a particular store, it may calculate the segment proportion for members who have a purchase history at that store.

However, it is not essential that the characteristic information generation unit 192 generates the awareness segment data and the segment proportion data. For example, a device other than the information generation device 100 may generate one or more of these datasets. Alternatively, in those cases where awareness score data and segment proportion data are not necessary for the formulation of the sales strategy, such as in a case where the sales strategy is formulated based on member awareness score data, the characteristic information generation unit 192 may refrain from generating these dataset.

In a case where an action in the sales strategy is performed based on the member awareness score data, the action processing unit 193 executes the action or a part of the action. In particular, the action processing unit 193 generates data of a notification for the member, such as introducing a product to the member, and transmits the notification to the member's smartphone 921 via the communication unit 110. Transmitting a notification to the member's smartphone 921 is also referred to as transmitting a notification to the member.

The target individual determination unit 194 determines the member targeted for the action. In particular, in a case where the action processing unit 193 transmits a notification to a member, the target individual determination unit 194 determines the individual targeted for notification transmission. The method by which the target individual determination unit 194 determines the member targeted for an action is not limited to a specific one.

For example, in a case where a particular store is the target of a sales strategy, the target individual determination unit 194 may determine a member that is determined to have a relatively high likelihood of using that store based on the member awareness score data, as the member to be targeted for the action.

For example, a method for calculating the likelihood that a particular member will use a particular store may be predefined based on the degree of match between the characteristics of the target customers for that store and the awareness score of the member. The target individual determination unit 194 may then apply the calculation method to the member awareness score data of each member to calculate the likelihood that the member will use the store targeted for the sales strategy. The target individual determination unit 194 may then compare the calculated likelihood with a predetermined threshold value, and if the likelihood is higher than the threshold value, determine that the member is relatively likely to use the store.

Alternatively, the target individual determination unit 194 may determine a member who has a purchase history at the store as the member targeted for the action. Alternatively, the target individual determination unit 194 may determine all members as members targeted for the action.

Also, in a case where a particular product is the target of a sales strategy, the target individual determination unit 194 may determine a member that is determined to have a relatively high likelihood of purchasing that product based on the member awareness score data, as the member to be targeted for the action.

For example, a method for calculating the likelihood that a particular member will purchase a particular product may be predefined based on the degree of match between the product score of the product and the awareness score of the member. Alternatively, the characteristics of the product's target customers may be used instead of the product score of the product.

The target individual determination unit 194 may then apply the calculation method to the member awareness score data of each member to calculate the likelihood that the member will purchase the product targeted for the sales strategy. The target individual determination unit 194 may then compare the calculated likelihood with a predetermined threshold value, and if the likelihood is higher than the threshold value, determine that the member is relatively likely to purchase the product.

Alternatively, the target individual determination unit 194 may determine a member who has a purchase history of the product as the member targeted for the action. Alternatively, the target individual determination unit 194 may determine all members as members targeted for the action.

The target product determination unit 195 determines the product targeted for the action. In particular, in a case where the action processing unit 193 transmits a notification to a member, the target product determination unit 195 determines the product targeted for the notification. The method by which the target product determination unit 195 determines the product targeted for an action is not limited to a specific one.

For example, in a case where a particular store is targeted for a sales strategy, the target product determination unit 195 may determine the product to be targeted for the action based on the awareness score data of a member who has a purchase history at the store, selecting a product that is determined to have a relatively high likelihood of being purchased by the member.

For example, as mentioned above, a method for calculating the likelihood that a particular member will purchase a particular product may be predefined based on the degree of match between the product score of the product and the awareness score of the member. Alternatively, the characteristics of the product's target customers may be used instead of the product score of the product.

The target individual determination unit 194 may calculate the average likelihood value that a member with a purchase history at the store will purchase each product sold at the store targeted for the sales strategy, as well as each product planned to be sold at the store, based on the purchase history at that store. The target individual determination unit 194 may then compare the calculated average likelihood value with a predetermined threshold value, and if the average value is higher than the threshold value, determine that the member is relatively likely to purchase the product.

Alternatively, the target product determination unit 195 may determine the product with the highest calculated average value as the product to be targeted for the action.

Alternatively, the target product determination unit 195 may determine as the product to be targeted for the action, those products sold at the store that are determined to have lower sales compared to other stores.

In a case where a particular product is the target for a sales strategy, the target product determination unit 195 may determine that the product is the product to be targeted for the action.

The action data generation unit 196 generates data to be used for an action.

For example, in the case of an action to invite a member to a product, the action data generation unit 196 generates transmission data for inviting the member to the product. The transmission data to invite members to a product is also referred to as invitation data.

The action data generation unit 196 is an example of the proposal information generation means.

The action data generation unit 196 may generate the invitation data by attaching the product name of the invitation target product and the image of the invitation target product to an invitation data template.

In the case of an action for a member, the transmission processing unit 197 transmits the data used for the action generated by the action data generation unit 196, to the smartphone 921 of the member determined by the target individual determination unit 194, via the communication unit 110.

For example, in the case of an action to invite a member to a product, the transmission processing unit 197 transmits the invitation data via the communication unit 110 to the smartphone 921 of the member determined by the target individual determination unit 194.

The transmission processing unit 197 is an example of the invitation information transmission means.

Psychological score data, awareness segment data, or segment proportion data can be used as reference materials in a case where planning campaigns for stores, chains, or companies, for example.

For example, by referring to the segment proportion data for a particular store, one can gain insights into the psychological tendencies of its customers, such as the prevalence of health-conscious individuals, individuals interested in new products, or family-oriented individuals among the store's customers. In a case where determining which type of campaign would be effective at the store, it is conceivable to consider the psychological tendencies of its customers.

Psychological score data, awareness segment data, or segment proportion data can be used as reference materials, for example, in a case where planning a product or developing a private brand.

For example, by referring to the segment proportion data for a particular company, one can gain insights into the psychological tendencies of its customers. In a case where planning a product or developing a private brand, the company may consider the psychological tendencies of its customers in a case where evaluating product types, product concepts or brand concepts, pricing, and marketing strategies.

Also, as described above, in a case where the action processing unit 193 transmits a product invitation to a member, it can refer to the awareness score data to determine either the target customer, the target product, or both. The action processing unit 193 may also transmit product advertisements to a member. Alternatively, the action processing unit 193 may transmit data containing benefits, such as coupons, to a member.

Moreover, the action processing unit 193 may transmit information about a store, chain, company, or brand to a member, either in addition to or as an alternative to product invitations. In such a case, the action processing unit 193 may use awareness score data to determine either the target customer, the content of the invitation, or both. Moreover, the action processing unit 193 may transmit product advertisements to a member, or transmit data containing benefits, such as coupons, to a member.

Psychological score data, awareness segment data, or segment proportion data may also be used as a reference for mail order sales. The mail order sales referred to here may be, but are not limited to, electronic commerce. For example, catalog sales or TV shopping may be conducted as communication media.

For example, the awareness scores of customers at a physical store of a certain company may be used as reference information for determining the target individuals to be invited to mail-order sales, determining the media or methods of mail-order sales invitations, determining the media or methods of mail-order sales, or determining the wording or images for the mail-order sales invitations.

For example, the target individual determination unit 194 may determine target individuals for mail-order sales invitations based on the awareness score data. The transmission processing unit 197 may then transmit a mail-order sales invitation to the smartphone 921 of each member, determined as the target individual for mail-order sales, via the communication unit 110.

The target individual determination unit 194 is an example of the target individual determination means. As mentioned above, the transmission processing unit 197 is an example of the invitation information transmission means.

Awareness score data and product score data may also be referenced in a case where conducting Recency Frequency Monetary (RFM) analysis on customers.

For example, consider the case where customers of a particular company or store are class-classified using RFM analysis, and actions are considered to improve customers' ranking positions (increasing purchases) or prevent customers from estranging (prevent customers from discontinuing use of the store) based on the historical information of the RFM analysis results.

In this case, a product that has a product score with a strong relevance with the awareness score of customers who have risen in ranking in the RFM analysis may be proposed to the company or store as part of its product lineup or sales enhancement campaigns.

Additionally, a product that has a product score with a strong relevance with the awareness score of estranging customers in the RFM may be proposed to the company or store as part of its product lineup or sales enhancement campaigns.

The action data generation unit 196 may generate data for making a proposal to the company or store. For example, the action data generation unit 196 may generate information indicating a product to be proposed as products to be sold at one or more stores based on the awareness scores of customers of one or more stores and the product scores of each product.

As mentioned above, the action data generation unit 196 is an example of the proposal information generation means.

Moreover, the action data generation unit 196 may generate information indicating products proposed to be sold at one or more stores, which have a product score with a correlation higher than a predetermined condition with the awareness scores of customers selected in the RFM analysis as influencing changes in store sales.

For example, if the awareness segment data of customers who are rapidly rising in rankings in the RFM analysis at a particular store indicates that they are interested in new products, it may be considered to reference the product score data and propose the product that individuals interested in new products are purchasing as a product to be sold at that store. Alternatively, it may be considered to make proposals to the store, such as increasing the number of new products sold at the store, issuing coupons for new products, arranging products on shelves so that new products are more noticeable, or regularly setting up sections in the store to introduce new products. Also in the case where the awareness segment data of customers identified as estranging in the RFM analysis indicates that they are interested in new products, proposals similar to the above may be made to the store.

Furthermore, in the case where the awareness segment data of customers who have moved up in ranking in the RFM analysis indicates that they are health-conscious, it may be considered to make proposals to the store, such as increasing the range of supplement products, issuing coupons for health-related products, arranging products on shelves to make health-related items more noticeable, or regularly setting up sections in the store to introduce health-related products.

Time-series data of awareness scores may also be used in sales strategies.

For example, the characteristic information generation unit 192 may generate the awareness score data of each member at regular intervals, such as every six months. The storage unit 180 may store the time-series data of the awareness score for each member. Alternatively, the storage unit 180 may store, for each member, time-series data of the awareness segment in addition to or instead of the time-series data of the awareness score.

For example, the temporal changes in a particular member's awareness score may be used as reference information for determining an action to be taken toward that member. Furthermore, the temporal changes in the member's awareness score may be used as reference information to determine whether or not to take action toward that member.

The target product determination unit 195 may determine a product to be introduced to a particular member based on the product score and the temporal changes in the awareness score of the member. The transmission processing unit 197 may then transmit an invitation of the determined product to the smartphone 921 of the member via the communication unit 110.

The target product determination unit 195 is an example of the invitation produced determination means. The awareness score is an example of information that indicates an individual's psychological characteristic. The product score is an example of information that indicates the relationship between a product and the psychological characteristics of an individual who purchased the product.

For example, if a particular member's awareness score indicates an increase in the “family-oriented” score value, a coupon for products with a “family-oriented” score value above a predetermined condition in the product score may be issued to the member. The issuance of coupons may be performed by the information generation device 100, or alternatively, by another device or a person.

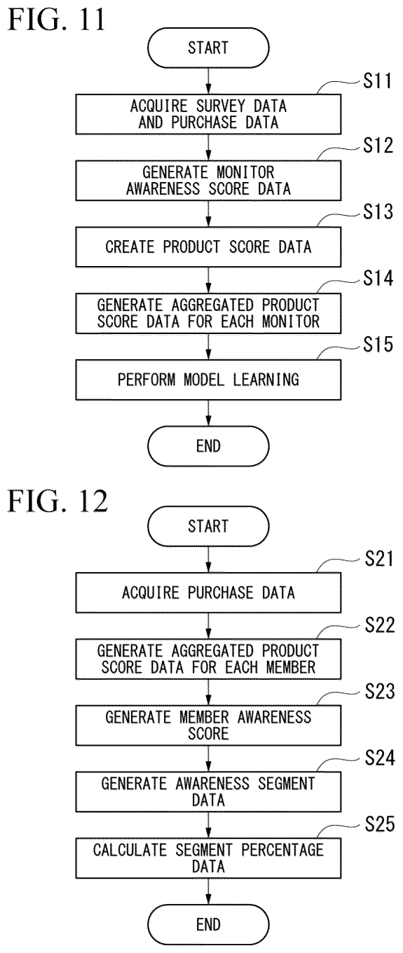

FIG. 11 is a diagram showing an example of a procedure through which the information generation device 100 performs preprocessing. FIG. 11 shows an example of a processing procedure through which the characteristic information generation unit 192 generates training data for model training, and the learning unit 191 performs the learning of the model.

In the process of FIG. 11, the information generation device 100 acquires survey data and purchase data (Step S11).

For example, the smartphone 921 may transmit survey data in response to the input of responses to the survey from the monitor. The communication unit 110 may receive the survey data from the smartphone 921, and the storage unit 180 may store the survey data.

Also, the POS system 910 may generate and transmit purchase data by reading the point card and performing the register operation in a case where a product is purchased. The communication unit 110 may then receive the purchase data from the POS system 910, and the storage unit 180 may store the purchase data.

Next, the characteristic information generation unit 192 generates monitor awareness score data based on the survey data (Step S12). For example, as mentioned above, the psychographic items in the survey may include the same items as those in the monitor awareness score. Then, the characteristic information generation unit 192 may convert the responses to the psychographic items in the survey into scores and generate the monitor awareness score data.

Next, the characteristic information generation unit 192 generates product score data based on the monitor awareness score data and the purchase data (Step S13). For example, as mentioned above, the items of the product score data may be the same as the items of the awareness score data. Then, the characteristic information generation unit 192 may calculate the average value for each item of the awareness scores of the monitors who purchased a certain product, as the product score value of the product.

Next, the characteristic information generation unit 192 generates product score aggregate data for each monitor based on the purchase data (purchase history data) for each monitor and product score data (Step S14). For example, as mentioned above, the product score aggregate value may be an average value of the product score values of the products purchased by the target individual within a predetermined period for each product score item. Then, the characteristic information generation unit 192 may calculate the product score aggregate value by averaging the product score values for each item.

Next, the learning unit 191 performs model learning using the purchase data (purchase history data) for each monitor and the product score aggregate data (Step S15). For example, as mentioned above, the learning unit 191 may use the vector of product score aggregate values from the product score aggregate data for each monitor as input to the model, and the vector of awareness score values from the awareness score data for that monitor as the ground truth, to train the model using training data.

After Step S15, the information generation device 100 ends the processing of FIG. 11.

FIG. 12 is a diagram showing an example of a procedure through which the information generation device 100 performs processing using product purchase data of a member. FIG. 12 shows an example of a processing procedure in the case where the characteristic information generation unit 192 generates segment proportion data for a particular store.

In the process of FIG. 12, the information generation device 100 acquires purchase data (Step S21). For example, as mentioned above, the POS system 910 may generate and transmit purchase data by reading the point card and performing the register operation in a case where a product is purchased. The communication unit 110 may then receive the purchase data from the POS system 910, and the storage unit 180 may store the purchase data.

Next, the characteristic information generation unit 192 generates product score aggregate data for each member based on the purchase data (purchase history data) for each member and product score data (Step S22). For example, as mentioned above, the product score aggregate value may be an average value of the product score values of the products purchased by the target individual within a predetermined period for each product score item. Then, the characteristic information generation unit 192 may calculate the product score aggregate value by averaging the product score values for each item.

Next, the characteristic information generation unit 192 inputs the product score aggregate data for each member into the model to generate member awareness score data (Step S23). In particular, the characteristic information generation unit 192 generates awareness score data for non-monitor members (members other than those who responded to the survey).

As for the awareness score data of the monitors, the awareness score data generated in Step S12 of FIG. 11 can be used. Alternatively, in Step S23, the characteristic information generation unit 192 may also generate monitor awareness score data.

Next, the characteristic information generation unit 192 generates awareness segment data based on the awareness score data (Step S24). For example, as mentioned above, for each psychological characteristic class, the values for each item of the awareness score may be weighted and summed, and an equation may be defined to calculate the score value of the class. Then, the characteristic information generation unit 192 may calculate the score value for each class for each member and determine the class with the highest score value as the psychological characteristic class of the member.

Next, the characteristic information generation unit 192 generates segment proportion data based on the awareness segment data (Step S25). For example, as mentioned above, the characteristic information generation unit 192 may calculate the proportion of members belonging to each psychological characteristic class among the members that have a purchase history at the store targeted for segment proportion data generation.

After Step S25, the information generation device 100 ends the processing of FIG. 12.

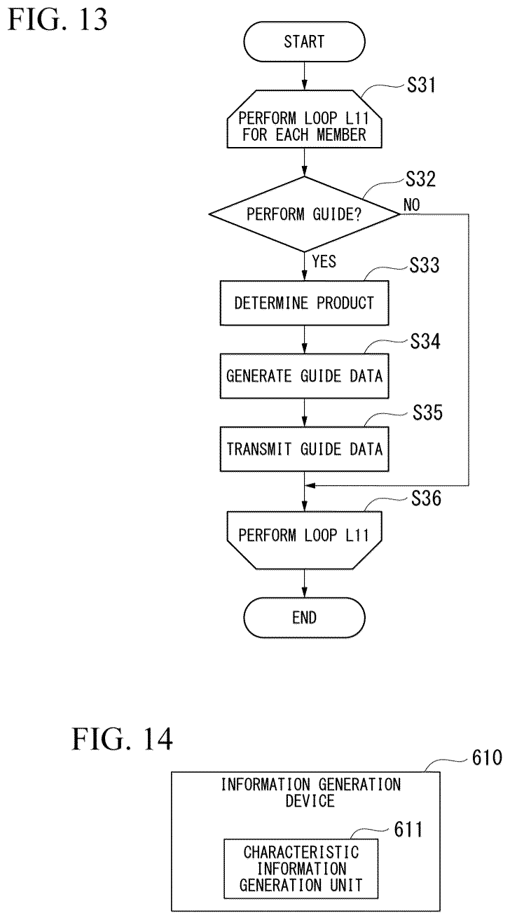

FIG. 13 is a diagram showing an example of a procedure through which the information generation device 100 performs processing of inviting a member to a product.

In the processing of FIG. 13, the action processing unit 193 starts a loop L11 for performing a process for each member (Step S31). The member targeted for the process in loop L11 is also referred to as target member.

Next, the target individual determination unit 194 determines whether or not to invite a target member to a product (Step S32). For example, as mentioned above, in a case where a particular store is the target of a sales strategy, the target individual determination unit 194 may determine a member that is determined to have a relatively high likelihood of using that store based on the member awareness score data, as the member to be targeted for the action. Also, in a case where a particular product is the target of a sales strategy, the target individual determination unit 194 may determine a member that is determined to have a relatively high likelihood of purchasing that product based on the member awareness score data, as the member to be targeted for the action.

If the target individual determination unit 194 determines to invite the target member to a product (Step S32: YES), the target product determination unit 195 determines the product to which the target member is invited (Step S33). For example, as mentioned above, in a case where a particular store is targeted for a sales strategy, the target product determination unit 195 may determine the product to be targeted for the action based on the awareness score data of a member who has a purchase history at the store, selecting a product that is determined to have a relatively high likelihood of being purchased by the member. Moreover, in a case where a particular product is the target for a sales strategy, the target product determination unit 195 may determine that the product is the product to be targeted for the action.

Next, the action data generation unit 196 generates invitation data for inviting the target member to the product (Step S34). For example, as mentioned above, the action data generation unit 196 may generate the invitation data by attaching the product name of the invitation target product and the image of the invitation target product to an invitation data template.

Next, the transmission processing unit 197 transmits the information data to the smartphone 921 of the target member via the communication unit 110 (Step S35).

Next, the action processing unit 193 performs a termination process for the loop L11 (Step S36). Specifically, the action processing unit 193 determines whether or not the process of loop L11 has been performed for all registered members. If it is determined that there are still members for whom the process in the loop L11 has not been performed, the action processing unit 193 continues to perform the process of the loop L11 for these unprocessed members.

On the other hand, if it is determined that the process of loop L11 has been performed for all registered members, the action processing unit 193 ends the loop L11.

In a case where the action processing unit 193 ends the loop L11 in Step S36, the information generation device 100 ends the processing of FIG. 13.

Furthermore, in Step S32, if the target individual determination unit 194 determines not to invite the target member to the product (Step S32: NO), the process proceeds to Step S36.

As described above, the characteristic information generation unit 192 generates information indicating a characteristic of an individual by inputting information based on the individual's product purchase history into a model that outputs information indicating a characteristic upon receiving input of information based on product purchase history.

According to the information generation device 100, information indicating a characteristic of an individual who has not participated in a survey (for example, a member) can also be obtained. The information indicating a characteristic of an individual can be used for developing sales strategies.

Moreover, according to the information generation device 100, information indicating an individual's characteristics is generated using a model, and in this regard, it is thus expected that the information can be generated with a relatively low computational load and in a relatively short period of time.

Moreover, the characteristic information generation unit 192 generates information indicating a psychological characteristic of an individual by inputting information based on the individual's product purchase history into a model (awareness score data generation model) that outputs information indicating a psychological characteristic upon receiving input of information based on product purchase history.

According to the information generation device 100, it is possible to obtain information indicating customers' psychological characteristics, which cannot be obtained through objective observation. The information indicating customers' psychological characteristics can be used for developing sales strategies.

Moreover, the information indicating psychological characteristics is information that, for an individual, indicates a degree of applicability for each psychological characteristic item set as an item of a psychological characteristic. The information based on product purchase history is information that, for each product purchased by an individual, indicates relevance between the product and each of the psychological characteristic items, and is information aggregated for the individual.

According to the information generation device 100, it is possible to quantitatively estimate the psychological characteristics of an individual member. According to the information generation device 100, in this regard, it is expected that a more refined sales strategy can be developed, as compared to estimating the psychological characteristics of each member qualitatively (using a YES/NO approach). It is expected that members will be able to receive more appropriate information that is more in line with their own psychological characteristics.

Moreover, the information that indicates relevance between the product and each of the psychological characteristic items is information that, for each individual who purchased that product and for each of the psychological characteristic items, indicates a degree of applicability of that psychological characteristic item to that individual, and is information aggregated for each of the psychological characteristic items.

According to the information generation device 100, the relevance between a product and each of the psychological characteristic items can be statistically calculated using information indicating the psychological characteristics of the purchaser of the product. According to the information generation device 100, in this regard, it is expected that the relevance between products and psychological characteristic items can be calculated with relatively high accuracy.

Moreover, the learning unit 191 performs learning of a model such that a difference is minimized between information indicating a psychological characteristic of an individual, obtained by inputting information based on the individual's product purchase history into the model (awareness score data generation model), and information indicating a psychological characteristic of the individual obtained from a psychological characteristic survey of that individual.

According to the information generation device 100, by constructing an awareness score data generation model using a differentiable function, it is possible to use a gradient technique such as backpropagation for the training of the model. According to the information generation device 100, in this regard, it is expected that model training can be performed efficiently. Moreover, according to the information generation device 100, re-learning of the awareness score data generation model is possible, and in this regard, the accuracy of the model can be improved.

Moreover, one awareness score data generation model is provided for one store. The learning unit 191 performs the learning of the awareness score data generation model by using information that, for each product sold at the model's target store, aggregates information indicating relevance between the product and each psychological characteristic item, for each of the psychological characteristic items, regarding each purchaser.

The information generation device 100 performs the learning of the model using information based on the purchase history of products sold at the store that is the target store of the learning target model, resulting in using training data that excludes products not sold at the store. Performing the learning of the model using training data that excludes products not sold at the target store can be viewed as training the model using noise-free training data. According to the information generation device 100, in this regard, it is expected that it is possible to perform the learning of the model with relatively high accuracy.

The learning unit 191 performs the learning of the awareness score data generation model by using information that, for each product sold at the model's target store, aggregates information indicating relevance between the product and each psychological characteristic item, for each of the psychological characteristic items, regarding each purchaser with a product purchase history at the store.

The information generation device 100 trains the model using information about individuals who have a product purchase history at a store targeted for the training target model, resulting in using training data that excludes individuals who do not have a product purchase history at the store. Performing the learning of the model using training data that excludes individuals who do not have a product purchase history at the target store can be viewed as training the model using noise-free training data. According to the information generation device 100, in this regard, it is further expected that it is possible to perform the learning of the model with relatively high accuracy.

Moreover, the target individual determination unit 194 determines target individuals for mail-order sales invitations based on awareness score data. The transmission processing unit 197 transmits invitation information of mail-order sales to an individual determined as the target individual to be invited to the mail-order sales.

According to the information generation device 100, the target individual for mail-order sales can be determined based on the psychological characteristics of the individual. According to the information generation device 100, in this regard, it is expected that mail order invitations can be provided efficiently.

Moreover, the action data generation unit 196 generates information indicating a product to be proposed for sale at one or more stores based on information indicating a psychological characteristic of customers of the one or more stores, and information indicating relevance between the product and each psychological characteristic item. As described above, the awareness score is an example of information that indicates customers' psychological characteristics. The product score is an example of information indicating the relevance between a product and each of the psychological characteristic items.

According to the information generation device 100, a product proposed to be sold at a store can be determined based on the psychological characteristics of customers. According to the information generation device 100, in this regard, it is expected that effective proposals can be made.

Moreover, the action data generation unit 196 generates information that indicates, as a product to be proposed as a product sold at the one or more stores, a product indicating a value of relevance between the product and each of psychological characteristic items, the relevance being stronger than a predetermined condition with a psychological characteristic value of a customer selected as a customer influencing changes in sales of the store.

According to the information generation device 100, a product proposed to be sold at a store can be determined based on the psychological characteristics of customers that influence changes in sales at the store. According to the information generation device 100, in this regard, it is expected that effective proposals can be made.

Moreover, the target product determination unit 195 determines a product to which an individual is invited, based on temporal variation of information indicating a psychological characteristic of the individual and information indicating a relationship between a product and a psychological characteristic of an individual who purchased the product. The transmission processing unit 197 transmits an invitation to the determined product to that individual.

According to the information generation device 100, the product to which an individual is invited is determined based on the temporal changes in the psychological characteristics of the individual, and in this regard, it is thus expected that an invitation to an appropriate product can be offered at an appropriate timing.

### Second Example Embodiment

FIG. 14 is a diagram showing another configuration example of the information generation device according to at least one of the example embodiments. In the configuration shown in FIG. 14, an information generation device 610 includes a characteristic information generation unit 611.

With such a configuration, the characteristic information generation unit 611 generates information indicating a characteristic of an individual by inputting information based on the individual's product purchase history into a model that outputs information indicating a characteristic upon receiving input of information based on product purchase history.

The characteristic information generation unit 611 is an example of the characteristic information generation means.

According to the information generation device 610, information indicating a characteristic of an individual who has not participated in a survey can also be obtained. The information indicating a characteristic of an individual can be used for developing sales strategies.

Moreover, according to the information generation device 610, information indicating an individual's characteristics is generated using a model, and in this regard, it is thus expected that the information can be generated with a relatively low computational load and in a relatively short period of time.

The characteristic information generation unit 611 can be implemented using the functions of the characteristic information generation unit 192 and so forth shown in FIG. 2, for example.

### Third Example Embodiment

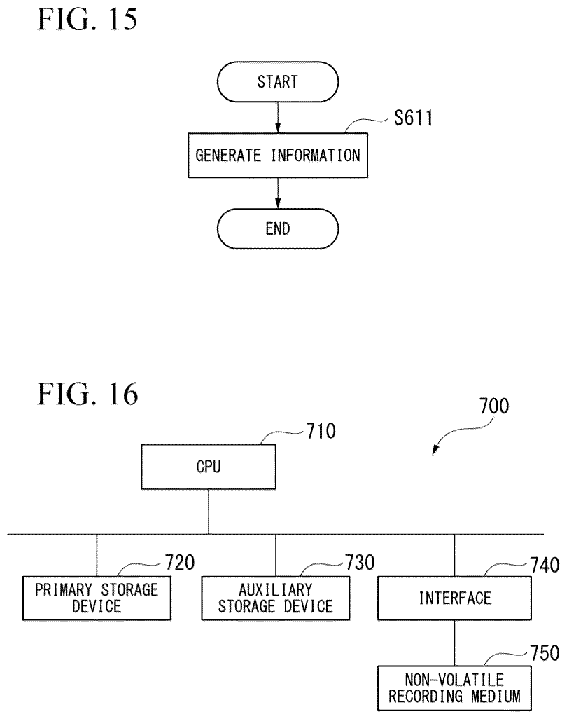

FIG. 15 is a diagram showing an example of a procedure of processing in an information generation method according to at least one of the example embodiments. The information generation method shown in FIG. 15 includes a step of generating information (Step S611).

In the step of generating information (Step S611), a computer generates information indicating a characteristic of an individual by inputting information based on the individual's product purchase history into a model that outputs information indicating a characteristic upon receiving input of information based on product purchase history.

According to the information generation method shown in FIG. 15, information indicating a characteristic of an individual who has not participated in a survey can also be obtained. The information indicating a characteristic of an individual can be used for developing sales strategies.

Moreover, according to the information generation method shown in FIG. 15, information indicating an individual's characteristics is generated using a model, and in this regard, it is thus expected that the information can be generated with a relatively low computational load and in a relatively short period of time.

FIG. 16 is a diagram showing a configuration example of a computer according to at least one of the example embodiments. In the configuration shown in FIG. 16, a computer 700 includes a CPU 710, a primary storage device 720, an auxiliary storage device 730, an interface 740, and a non-volatile recording medium 750.

One or more of the information generation device 100 and the information generation device 610 or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 secures, according to the program, memory storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

In the case where the information generation device 100 is implemented in the computer 700, operations of the processing unit 190 and each component thereof are stored in the form of a program in the auxiliary storage device 730. The CPU 710 reads out the programs from the auxiliary storage device 730, loads them on the primary storage device 720, and executes the processes described above, according to the programs.

Also, the CPU 710 secures a memory storage region in the primary storage device 720 for the storage unit 180, according to the program. Communication with another device performed by the communication unit 110 is executed by the interface 740 having a communication function and operating under the control of the CPU 710. Display of images performed by the display unit 120 is executed by the interface 740 having a display device and displaying various images under the control of the CPU 710. User operations are accepted through the operation input unit 130 by the interface 740 having an input device and accepting user operations under control of the CPU 710.

In the case where the information generation device 610 is implemented in the computer 700, operations of the information generation device 611 are stored in the auxiliary memory storage device 730 in a form of program. The CPU 710 reads out the programs from the auxiliary storage device 730, loads them on the primary storage device 720, and executes the processes described above, according to the programs.

Moreover, the CPU 710 secures a memory storage region in the primary storage device 720 for the processing to be performed by the information generation device 610, according to the program. Communication with another device performed by the information generation device 610 is executed by the interface 740 having a communication function and operating under the control of the CPU 710. Interaction between the information generation device 610 and a user is executed by the interface 740 having an input device and an output device, presenting information to the user through the output device under the control of CPU 710, and accepting user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that a program for executing some or all of the processes performed by the information generation device 100 and the information generation device 610 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built into a computer system. The above program may be a program for realizing a part of the functions described above, and may be a program capable of realizing the functions described above in combination with a program already recorded in a computer system.

The example embodiments of the present disclosure have been described in detail with reference to the drawings. However, the specific configuration of the disclosure is not limited to the example embodiments, and may include designs and so forth that do not depart from the scope of the present disclosure. Furthermore, the example embodiments described above may be combined with another example embodiment as appropriate.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

The whole or part of the example embodiments disclosed above can be described as, but not limited to, the following supplementary notes.

### (Supplementary Note 1)

An information generation device comprising
a characteristic information generation means that generates information indicating a characteristic of an individual by inputting information based on the individual's product purchase history into a model that outputs information indicating a characteristic upon receiving input of information based on product purchase history.

### (Supplementary Note 2)

The information generation device according to supplementary note 1, wherein
the characteristic information generation means generates information indicating a psychological characteristic of an individual by inputting information based on the individual's product purchase history into a model that outputs information indicating a psychological characteristic upon receiving input of information based on product purchase history.

### (Supplementary Note 3)

The information generation device according to supplementary note 2, wherein
the information indicating the psychological characteristic is information that, for an individual, indicates a degree of applicability for each psychological characteristic item set as an item of a psychological characteristic, and the information based on product purchase history is information that, for each product purchased by an individual, indicates relevance between the product and each of the psychological characteristic items, and is information aggregated for each psychological characteristic item for the individual.

### (Supplementary Note 4)

The information generation device according to supplementary note 3, wherein
the information that indicates relevance between the product and each of the psychological characteristic items is information that, for each individual who purchased that product and for each of the psychological characteristic items, indicates a degree of applicability of that psychological characteristic item to that individual, and is information aggregated for each of the psychological characteristic items.

### (Supplementary Note 5)

The information generation device according to any one of supplementary notes 2 to 4, comprising
a learning means that performs learning of the model such that a difference is minimized between information indicating a psychological characteristic of an individual, obtained by inputting information based on the individual's product purchase history into the model, and information indicating a psychological characteristic of the individual obtained from a psychological characteristic survey of that individual.

### (Supplementary Note 6)

The information generation device according to supplementary note 5, wherein
one of the models is provided for one store, and
the learning means performs the learning of the model by using information that, for each product sold at the model's target store, aggregates information indicating relevance between the product and each psychological characteristic item set as an item of psychological characteristic, for each of the psychological characteristic items, regarding each purchaser.

### (Supplementary Note 7)

The information generation device according to supplementary note 6, wherein
the learning means performs the learning of the model by using information that, for each product sold at the model's target store, aggregates information indicating relevance between the product and each psychological characteristic item, for each of the psychological characteristic items, regarding each purchaser with a product purchase history at the store.

### (Supplementary Note 8)

The information generation device according to any one of supplementary notes 2 to 7, comprising
a target individual determination means that determines a target individual to be invited to mail-order sales, based on the information indicating the psychological characteristic of the individual, generated by the characteristic information generation means for each individual, and
an invitation information transmission means that transmits invitation information of the mail order sales to an individual determined as the target individual to be invited to mail-order sales.

### (Supplementary Note 9)

The information generation device according to any one of supplementary notes 2 to 8, wherein
a proposal information generation means that generates information indicating a product to be proposed for sale at one or more stores based on information indicating a psychological characteristic of customers of the one or more stores, and information indicating relevance between the product and each psychological characteristic item set as an item of psychological characteristic.

### (Supplementary Note 10)

The information generation device according to supplementary note 9, wherein
the proposal information generation means generates information that indicates, as a product to be proposed as a product sold at the one or more stores, a product indicating a value of relevance between the product and each of psychological characteristic items, the relevance being stronger than a predetermined condition with a psychological characteristic value of a customer selected as a customer influencing changes in sales of the store.

### (Supplementary Note 11)

The information generation device according to any one of supplementary notes 2 to 10, comprising
an invitation produced determination means that determines a product to which an individual is invited, based on temporal variation of information indicating a psychological characteristic of the individual and information indicating a relationship between a product and a psychological characteristic of an individual who purchased the product, and
an invitation information transmission means that transmits an invitation to the determined product to that individual.

### (Supplementary Note 12)

An information generation method comprising
a step, performed by a computer, of
generating information indicating a characteristic of an individual by inputting information based on the individual's product purchase history into a model that outputs information indicating a characteristic upon receiving input of information based on product purchase history.

### (Supplementary Note 13)

The information generation method according to supplementary note 12, wherein
the step of generating information indicating a characteristic of an individual includes
a step, performed by the computer, of
generating information indicating a psychological characteristic of an individual by inputting information based on the individual's product purchase history into a model that outputs information indicating a psychological characteristic upon receiving input of information based on product purchase history.

### (Supplementary Note 14)

The information generation method according to supplementary note 13, wherein
the information indicating the psychological characteristic is information that, for an individual, indicates a degree of applicability for each psychological characteristic item set as an item of a psychological characteristic, and
the information based on product purchase history is information that, for each product purchased by an individual, indicates relevance between the product and each of the psychological characteristic items, and is information aggregated for each psychological characteristic item for the individual.

### (Supplementary Note 15)

The information generation method according to supplementary note 14, wherein
the information that indicates relevance between the product and each of the psychological characteristic items is information that, for each individual who purchased that product and for each of the psychological characteristic items, indicates a degree of applicability of that psychological characteristic item to that individual, and is information aggregated for each of the psychological characteristic items.

### (Supplementary Note 16)

The information generation method according to any one of supplementary notes 13 to 15, comprising
a step, performed by the computer, of
performing learning of the model such that a difference is minimized between information indicating a psychological characteristic of an individual, obtained by inputting information based on the individual's product purchase history into the model, and information indicating a psychological characteristic of the individual obtained from a psychological characteristic survey of that individual.

### (Supplementary Note 17)

The information generation method according to supplementary note 16, wherein
one of the models is provided for one store, and
the step of performing learning includes
a step, performed by the computer, of
performing the learning of the model by using information that, for each product sold at the model's target store, aggregates information indicating relevance between the product and each psychological characteristic item set as an item of psychological characteristic, for each of the psychological characteristic items, regarding each purchaser.

### (Supplementary Note 18)

The information generation method according to supplementary note 17, wherein
the step of performing learning includes
a step, performed by the computer, of
performing the learning of the model by using information that, for each product sold at the model's target store, aggregates information indicating relevance between the product and each psychological characteristic item, for each of the psychological characteristic items, regarding each purchaser with a product purchase history at the store.

### (Supplementary Note 19)

The information generation method according to any one of supplementary notes 13 to 18, comprising
steps, performed by the computer, of
determining a target individual to be invited to mail-order sales, based on the information indicating the psychological characteristic of the individual, generated for each individual, and
transmitting invitation information of the mail-order sales to an individual determined as the target individual to be invited to mail-order sales.

### (Supplementary Note 20)

The information generation method according to any one of supplementary notes 13 to 19, comprising
a step, performed by the computer, of
generating information indicating a product to be proposed for sale at one or more stores based on information indicating a psychological characteristic of customers of the one or more stores, and information indicating relevance between the product and each psychological characteristic item set as an item of psychological characteristic.

### (Supplementary Note 21)

The information generation method according to supplementary note 20,wherein
the step of generating information indicating a product to be proposed includes
a step, performed by the computer, of
generating information that indicates, as a product to be proposed as a product sold at the one or more stores, a product indicating a value of relevance between the product and each of psychological characteristic items, the relevance being stronger than a predetermined condition with a psychological characteristic value of a customer selected as a customer influencing changes in sales of the store.

### (Supplementary Note 22)

The information generation method according to any one of supplementary notes 13 to 21, comprising
steps, performed by the computer, of
determining a product to which an individual is invited, based on temporal variation of information indicating a psychological characteristic of the individual and information indicating a relationship between a product and a psychological characteristic of an individual who purchased the product, and
transmitting an invitation to the determined product to that individual.

### (Supplementary Note 23)

A program that causes
a computer to execute a step of
generating information indicating a characteristic of an individual by inputting information based on the individual's product purchase history into a model that outputs information indicating a characteristic upon receiving input of information based on product purchase history.

### (Supplementary Note 24)

The program according to supplementary note 23, wherein,
in the step of generating information indicating a characteristic of an individual, it causes the computer to execute a step of
generating information indicating a psychological characteristic of an individual by inputting information based on the individual's product purchase history into a model that outputs information indicating a psychological characteristic upon receiving input of information based on product purchase history.

### (Supplementary Note 25)

The program according to supplementary note 24, wherein
the information indicating the psychological characteristic is information that, for an individual, indicates a degree of applicability for each psychological characteristic item set as an item of a psychological characteristic, and
the information based on product purchase history is information that, for each product purchased by an individual, indicates relevance between the product and each of the psychological characteristic items, and is information aggregated for each psychological characteristic item for the individual.

### (Supplementary Note 26)

The program according to supplementary note 25, wherein
the information that indicates relevance between the product and each of the psychological characteristic items is information that, for each individual who purchased that product and for each of the psychological characteristic items, indicates a degree of applicability of that psychological characteristic item to that individual, and is information aggregated for each of the psychological characteristic items.

### (Supplementary Note 27)

The program according to any one of supplementary notes 24 to 26, wherein
it causes the computer to execute a step of
performing learning of the model such that a difference is minimized between information indicating a psychological characteristic of an individual, obtained by inputting information based on the individual's product purchase history into the model, and information indicating a psychological characteristic of the individual obtained from a psychological characteristic survey of that individual.

### (Supplementary Note 28)

The program according to supplementary note 27, wherein
one of the models is provided for one store, and
in the step of performing learning, it causes the computer to execute a step of
performing the learning of the model by using information that, for each product sold at the model's target store, aggregates information indicating relevance between the product and each psychological characteristic item set as an item of psychological characteristic, for each of the psychological characteristic items, regarding each purchaser.

### (Supplementary Note 29)

The program according to supplementary note 28, wherein
in the step of performing learning, it causes the computer to execute a step of
performing the learning of the model by using information that, for each product sold at the model's target store, aggregates information indicating relevance between the product and each psychological characteristic item, for each of the psychological characteristic items, regarding each purchaser with a product purchase history at the store.

### (Supplementary Note 30)

The program according to any one of supplementary notes 24 to 29, wherein
it causes the computer to execute steps of
determining a target individual to be invited to mail-order sales, based on the information indicating the psychological characteristic of the individual, generated for each individual, and
transmitting invitation information of the mail order sales to an individual determined as the target individual to be invited to mail-order sales.

### (Supplementary Note 31)

The program according to any one of supplementary notes 24 to 30, wherein
it causes the computer to execute a step of
generating information indicating a product to be proposed for sale at one or more stores based on information indicating a psychological characteristic of customers of the one or more stores, and information indicating relevance between the product and each psychological characteristic item set as an item of psychological characteristic.

### (Supplementary Note 32)

The program according to supplementary note 31, wherein
in the step of generating information indicating a product to be proposed, it causes the computer to execute a step of
generating information that indicates, as a product to be proposed as a product sold at the one or more stores, a product indicating a value of relevance between the product and each of psychological characteristic items, the relevance being stronger than a predetermined condition with a psychological characteristic value of a customer selected as a customer influencing changes in sales of the store.

### (Supplementary Note 33)

The program according to any one of supplementary notes 24 to 32, wherein
it causes the computer to execute steps of
determining a product to which an individual is invited, based on temporal variation of information indicating a psychological characteristic of the individual and information indicating a relationship between a product and a psychological characteristic of an individual who purchased the product, and
transmitting an invitation to the determined product to that individual.

What is claimed is:

1. An information generation device comprising:
at least one memory configured to store instructions; and
at least one processor configured to execute the instructions to:
generate second output information indicating a characteristic of an individual by inputting second input information based on the individual's product purchase history into a first model,
wherein the first model outputs first output information indicating a characteristic in respect to receiving input of first input information based on product purchase history.

2. The information generation device according to claim 1, wherein the at least one processor is configured to execute the instructions to:
input the second input information based on the individual's product purchase history into a second model that outputs third output information indicating a psychological characteristic upon receiving input of the first input information based on the product purchase history; and
acquire fourth output information indicating a psychological characteristic of the individual.

3. The information generation device according to claim 2, wherein
the third output information indicating the psychological characteristic is information that, for the individual, indicates a degree of applicability for each psychological characteristic item set as an item of a psychological characteristic, and
the first input information based on the product purchase history is information that, for each product purchased by the individual, indicates relevance between the product and each of the psychological characteristic items, and is information aggregated for each psychological characteristic item for the individual.

4. The information generation device according to claim 3, wherein
the information that indicates relevance between the product and each of the psychological characteristic items is information that, for each individual who purchased the product and for each of the psychological characteristic items, indicates a degree of applicability of that psychological characteristic item to the individual, and is information aggregated for each of the psychological characteristic items.

5. The information generation device according to claim 2, wherein the at least one processor is configured to execute the instructions to train the second model such that a difference is minimized between the fourth output information indicating the psychological characteristic of the individual, obtained by inputting the second input information based on the individual's product purchase history into the second model, and fifth output information indicating a psychological characteristic of the individual obtained from a psychological characteristic survey of the individual.

6. The information generation device according to claim 2, wherein the at least one processor is configured to execute the instructions to:
determine a target individual to be invited to mail-order sales, based on the fourth output information indicating the psychological characteristic of the individual; and
transmit invitation information of the mail-order sales to the individual determined as the target individual to be invited to mail-order sales.

7. The information generation device according to claim 2, wherein the at least one processor is configured to execute the instructions to generate information indicating a product to be proposed for sale at one or more stores based on the fourth output information indicating the psychological characteristic of customers of the one or more stores, and information indicating relevance between the product and each psychological characteristic item set as an item of psychological characteristic.

8. The information generation device according to claim 2, wherein the at least one processor is configured to execute the instructions to:
determine a product to which the individual is invited, based on temporal variation of the fourth output information indicating the psychological characteristic of the individual and information indicating a relationship between a product and the psychological characteristic of the individual who purchased the product; and
transmit an invitation to the determined product to the individual.

9. An information generation method executed by a computer, the method comprising:
generating second output information indicating a characteristic of an individual by inputting second input information based on the individual's product purchase history into a first model,
wherein the first model outputs first output information indicating a characteristic in respect to receiving input of first input information based on product purchase history.

10. The information generation method according to claim 9, further comprising:
inputting the second input information based on the individual's product purchase history into a second model that outputs third output information indicating a psychological characteristic upon receiving input of the first input information based on the product purchase history; and
acquiring fourth output information indicating a psychological characteristic of the individual.

11. The information generation method according to claim 10, wherein
the third output information indicating the psychological characteristic is information that, for the individual, indicates a degree of applicability for each psychological characteristic item set as an item of a psychological characteristic, and
the first input information based on the product purchase history is information that, for each product purchased by the individual, indicates relevance between the product and each of the psychological characteristic items, and is information aggregated for each psychological characteristic item for the individual.

12. The information generation method according to claim 11, wherein
the information that indicates relevance between the product and each of the psychological characteristic items is information that, for each individual who purchased the product and for each of the psychological characteristic items, indicates a degree of applicability of that psychological characteristic item to the individual, and is information aggregated for each of the psychological characteristic items.

13. The information generation method according to claim 10, further comprising training the second model such that a difference is minimized between the fourth output information indicating the psychological characteristic of the individual, obtained by inputting the second input information based on the individual's product purchase history into the second model, and fifth output information indicating a psychological characteristic of the individual obtained from a psychological characteristic survey of the individual.

14. The information generation method according to claim 10, further comprising:
determining a target individual to be invited to mail-order sales, based on the fourth output information indicating the psychological characteristic of the individual; and
transmitting invitation information of the mail-order sales to the individual determined as the target individual to be invited to mail order sales.

15. The information generation method according to claim 10, further comprising generating information indicating a product to be proposed for sale at one or more stores based on the fourth output information indicating the psychological characteristic of customers of the one or more stores, and information indicating relevance between the product and each psychological characteristic item set as an item of psychological characteristic.

16. The information generation method according to claim 10, further comprising:
determining a product to which the individual is invited, based on temporal variation of the fourth output information indicating the psychological characteristic of the individual and information indicating a relationship between a product and the psychological characteristic of the individual who purchased the product; and
transmitting an invitation to the determined product to the individual.

17. A non-transitory storage medium storing a program that causes a computer to execute:
generating second output information indicating a characteristic of an individual by inputting second input information based on the individual's product purchase history into a first model,
wherein the first model outputs first output information indicating a characteristic in respect to receiving input of first input information based on product purchase history.
